(19) United States
(12) Patent Application Publication
(10) Pub. No.: US 2007/0080619 A1
(43) Pub. Date: Apr. 12, 2007

(54) Bulb assembly

(76) Inventor: Yen Hao Lu, Taichung City (TW)

Correspondence Address: PRO-TECHTOR INTERNATIONAL SERVICES, 20775 NORADA CT., SARATOGA, CA, 95070, US

(21) Appl. No.: 11/195,217

(22) Filed: Aug. 2, 2005

(51) Int. Cl. H01J 1/88

(52) U.S. Cl. 313/263

(57) ABSTRACT

A bulb assembly includes a bulb having two conductive legs and a base which includes a first section with a recess defined in a top thereof and a second section. Two passages are defined through the second section and include two respective tapered guide surfaces which are in communication with the recess. The body of the bulb is engaged with the recess and the two conductive legs extend through the two passages. The guide surfaces assist the assemblers to easily insert the conductive legs in the passages.

### FIELD OF THE INVENTION

The present invention relates to a bulb assembly having a bulb and a base which includes two holes with tapered guide surfaces for guidance of insertion of the conductive legs of the bulb.

### BACKGROUND OF THE INVENTION

A conventional bulb assembly 40 is shown in FIGS. 4 and 5 and generally includes a bulb 42 having two conductive legs 421 and a base 41. The base 41 includes a first recess 411 defined in a top thereof and a second recess 412 which is located beneath the first recess 411. The first and second recesses 412, 413 are in communication with each other. Two holes 413 are defined through a bottom of the base 41 and communicate with the second recess 412 such that the bulb 42 is engaged with the first recess 411 and the two conductive legs 421 extend through the two holes 413. A separation wall 414 is located between the two holes 413 to prevent the two conductive legs 421 from in contact with each other. However, it is experienced that during installing the bulb 42 into the base 41, because the two holes 413 are located at the bottom of the bas 41 so that the two conductive legs 421 could hit the inner bottom of the second recess 412 and even be broken.

The present invention intends to provide a bulb assembly wherein the base includes tapered guide surfaces for guiding conductive legs of the bulb to extend through the holes in the base.

### SUMMARY OF THE INVENTION

The present invention relates to a bulb assembly which comprises a bulb including a body and two conductive legs. A base includes a first section and a second section, wherein a recess is defined in a top of the first section and two passages are defined through the second section. The two passages communicate with the recess. A separation wall is located between the two passages. The body of the bulb is engaged with the recess and the two conductive legs extend through the two passages.

The primary object of the present invention is to provide a bulb assembly wherein the two conductive legs are easily inserted in the passage of the base.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bulb assembly of the present invention;

FIG. 2 is an exploded view to show the bulb assembly of the present invention;

FIG. 3 is a cross sectional view of the bulb assembly of the present invention;

FIG. 4 is an exploded view to show a conventional bulb assembly, and

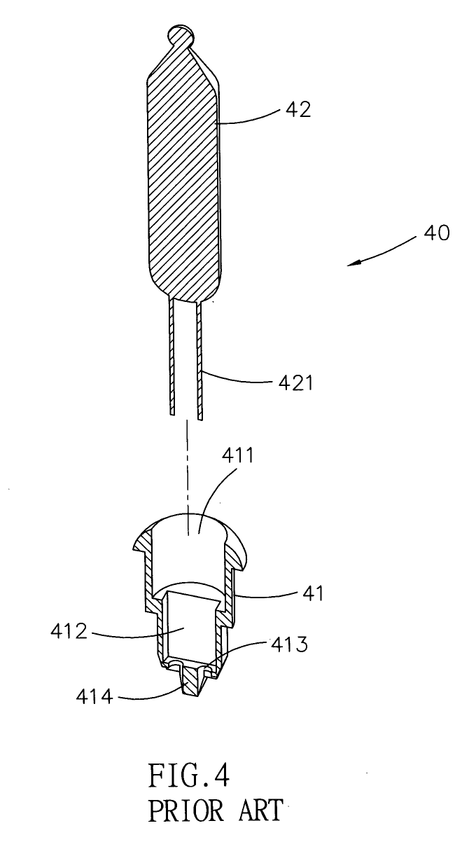

FIG. 5 is a cross sectional view of the conventional bulb assembly.

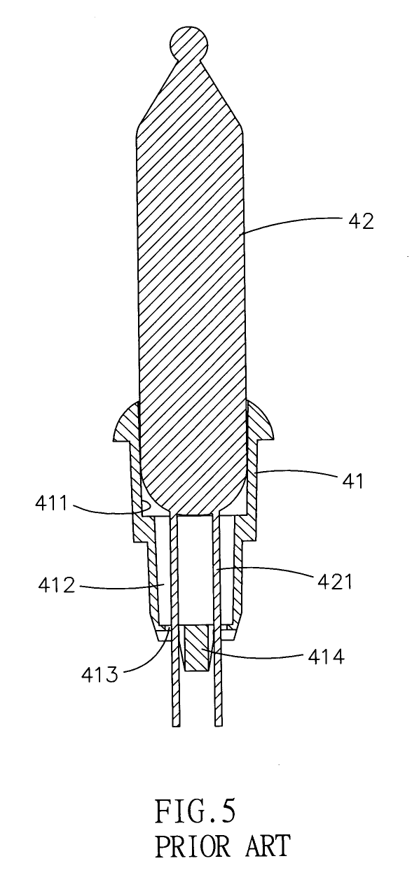

### DETAILED DESCRIPTION OF THE PREFERRED EMBODIMENT

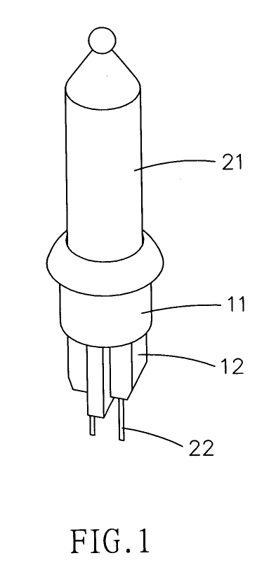

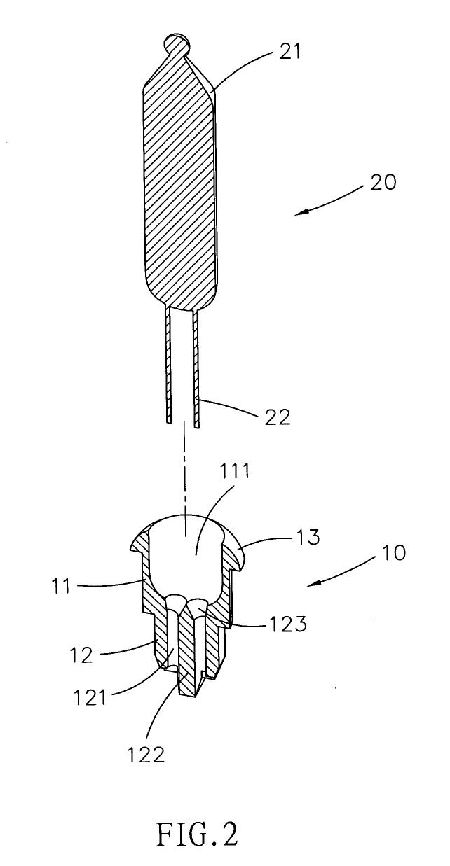

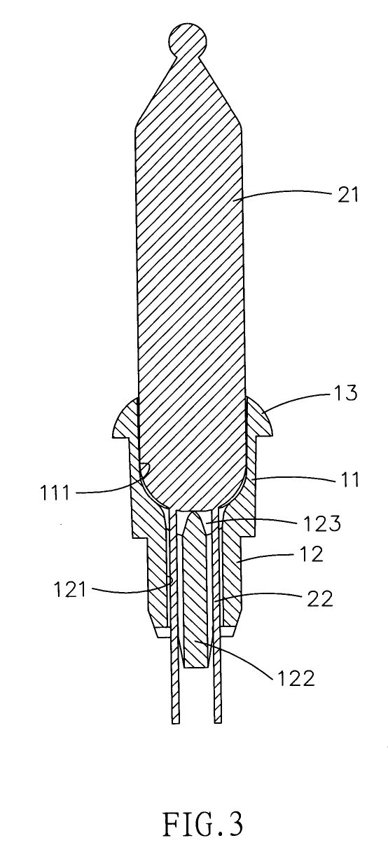

Referring to FIGS. 1 to 3, the bulb assembly of the present invention comprises a bulb 20 having a body 21 and two conductive legs 22 extend from an end of the body 21. A base 10 to which the bulb 20 is connected includes a first section 11 and a second section 12. A flange 13 extends radially outward from the first section 11. A recess 111 is defined in a top of the first section 11 and two passages 121 are defined through the second section 12. The two passages 121 communicate with the recess 111 and a separation wall 122 are located between the two passages 121. A tapered guide surface 123 is defined in an inner periphery of each of the two passages 121 and communicates with the recess 111.

The body 21 of the bulb 20 is engaged with the recess 111 and the two conductive legs 22 extend through the two passages 121. It is noted that the two conductive legs 22 are guided by the tapered guide surfaces 123 during assembling the body 21 and the base 10. In other words, during assembling, the two conductive legs 22 first contact the tapered guide surfaces 123 when inserting the body 21 into the recess 111 and the legs 22 are guided to be easily inserted into the passages 121. The conductive legs 22 are prevented from being broken because of hitting on the inner side of the recess 111 as known in the conventional bulb assembly 40. The separation wall 122 avoids the two conductive legs 22 from being in contact with other.

While we have shown and described the embodiment in accordance with the present invention, it should be clear to those skilled in the art that further embodiments may be made without departing from the scope of the present invention.

What is claimed is:

1. A bulb assembly comprising:
a bulb having a body and two conductive legs extending from an end of the body, and
a base including a first section and a second section, a recess defined in a top of the first section and two passages defined through the second section, the two passages communicating with the recess, a separation wall located between the two passages, the body of the bulb engaged with the recess and the two conductive legs extending through the two passages.

2. The assembly as claimed in claim 1, wherein a tapered guide surface is defined in an inner periphery of each of the two passages and communicates with the recess.

3. The assembly as claimed in claim 1, wherein a flange extends radially outward from the first section.
